(19) United States
(12) Patent Application Publication
(10) Pub. No.: US 2014/0129462 A1
(43) Pub. Date: May 8, 2014

(54) MULTIFACETED CANDIDATE SCREENING

(71) Applicant: INTERNATIONAL BUSINESS MACHINES CORPORATION, Armonk, NY (US)

(72) Inventors: Sameep Mehta, New Delhi (IN); Rakesh R. Pimplikar, Nagpur (IN); Karthik Visweswariah, Bangalore (IN); Lav R. Varshney, Yorktown Heights, NY (US); Amit K. Singh, Mumbai (IN)

(73) Assignee: INTERNATIONAL BUSINESS MACHINES CORPORATION, Armonk, NY (US)

(21) Appl. No.: 13/670,592

(22) Filed: Nov. 7, 2012

(51) Int. Cl. G06Q 10/06

(52) U.S. Cl. CPC G06Q 10/063112
USPC 705/321

(57) ABSTRACT

A method, system and computer program product are disclosed for candidate screening. In one embodiment, the method comprises identifying a multitude of dimensions of a specified job, assigning a weight to each of the dimensions, and determining whether each of a group of candidate satisfies the weights assigned to the dimensions. In an embodiment, a score is assigned to each candidate based on the weights assigned to the dimensions, and the number of the candidates score above a threshold is determined. In an embodiment, if the number of the candidates that have a score above the threshold is less than a defined number, one or more of the weights is adjusted, and the candidates are rescored based on these adjusted weights. In embodiments of the invention, the weights are adjusted based on the number of the candidates that score above the threshold, or based on the other weights.

### BACKGROUND OF THE INVENTION

This invention generally relates to workforce management, and more specifically, to screening employment candidates.

Workforce management is the strategic alignment of an organizations' human capital with its business objectives; and workforce management affects the full life cycle and range of human resource activities including recruitment, hiring, training and compensation. The goal of workforce management is to recruit, develop and use the right people at the right places at the right times to achieve objectives of both the organization and the individual. Efficiently planning and managing a workforce is an important, and difficult, challenge for many organizations.

A critical part of workforce management is the recruitment and hiring of people. Hiring the right talent is a challenge faced by all companies, and this challenge may be amplified by a high volume of applicants if a business is labor intensive and growing.

### BRIEF SUMMARY

Embodiments of the invention provide a method, system and computer program product for multidimensional candidate screening. In one embodiment, the method comprises identifying a multitude of dimensions of a specified job; assigning a weight to each of the dimensions based on defined constraints; and for each of a multitude of candidates for the specified job, determining whether said each candidate satisfies the weights assigned to each of the dimensions. In an embodiment, the method further comprises assigning a score to each of the candidates based on whether said each candidate satisfies the weights assigned to said dimensions, and determining the number of the candidates that have a score above a defined threshold. In an embodiment, if the number of the candidates that have a score above the defined threshold is less than a defined number, one or more of the weights is adjusted; and the method further comprise repeating the determining whether said each candidate satisfies the weights assigned to each of the dimensions, assigning a score to each of the candidates, and determining the number of the candidates that have a score above the defined threshold.

In one embodiment, weights are assigned to each of the dimensions by assigning an importance to each of the dimensions, and assigning the weight to each of the dimensions based on the importance assigned to said each of the dimensions.

In an embodiment, the weights are adjusted based on the number of the candidates that have a score above the defined threshold.

In one embodiment, at least one of the weights is adjusted based on the other weights assigned to the dimensions.

In one embodiment, at least one of the weights is adjusted based on the scores assigned to one or more of the candidates.

In an embodiment, the defined number is one.

In one embodiment, a score is assigned to each of the candidates by ordering the dimensions according to a defined ordering principle, and assigning a score to each of the candidates based on the order of the dimensions to which the weights are assigned.

In an embodiment, the dimensions of the specified job include: a technical match between each of the candidates and the specified job; a screening match representing a probability that each of the candidates will pass a screening test; an onboard probability representing a probability that each candidate would accept an offer for the specified job; and an early attrition probability representing a probability that each candidate would permanently leave the organization that is offering the specified job, within a specified time of joining the organization.

In an embodiment, the defined constraints include: a time horizon indicating a time at which the organization needs to employ a person for the specified job; a skill type indicating an availability of the type of skill needed for the specified job; and a role type indicating a type of role for a person who accepts the specified job.

In one embodiment, a computer system, executing a candidate screening program, is used to determine whether each candidate satisfies the weights assigned to each of the dimensions, to assign a score to each of the candidates based on whether each candidate satisfies the weights assigned to said dimensions, and to determine the number of the candidates that have a score above the defined threshold.

### BRIEF DESCRIPTION OF THE DRAWINGS

FIG. 1 gives an overview of a typical recruitment process.

FIG. 2 identifies some dimensions that can affect the quality of an employment candidate.

FIG. 3 lists some specific costs of the hiring process.

FIG. 4 identifies a number of business constraints that may be taken into account during the hiring process.

FIG. 5 is a flow chart illustrating an embodiment of the present invention.

FIG. 6 illustrates several examples of business constraints and assigned weights.

FIG. 7 shows a computing environment in which the present invention may be implemented.

### DETAILED DESCRIPTION

As will be appreciated by one skilled in the art, embodiments of the present invention may be embodied as a system, method or computer program product. Accordingly, embodiments of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments of the present invention may take the form of a computer program product embodied in any tangible medium of expression having computer usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium, upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

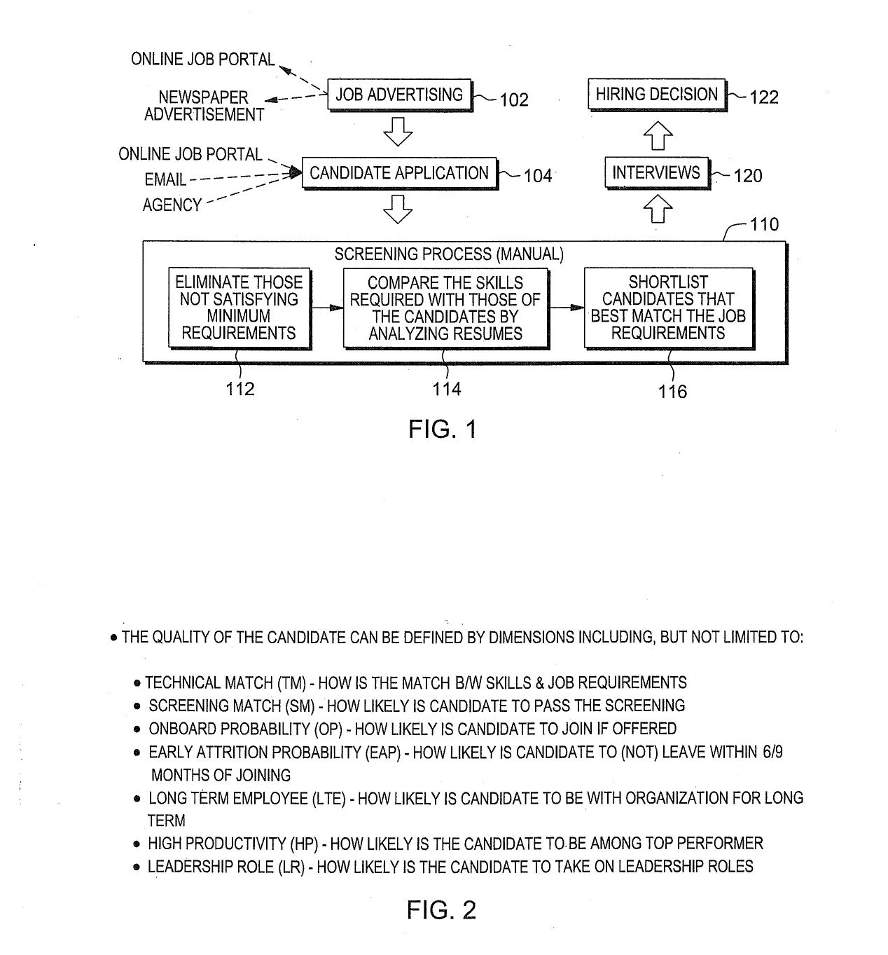

The present invention relates to screening employment candidates, and FIG. 1 gives an overview of a typical recruitment process. The process starts when a business unit decides to hire employees to meet its business objectives. The business unit creates a job profile that specifies the role, job category, essential skills, location of the opening and a brief job description detailing the nature of work. The job profile might also specify the total work experience that the prospective employee should possess, along with the desired experience level for each skill. The job openings are advertised, at 102, through multiple channels like on-line job portals, newspaper advertisements, etc. Candidates who are interested to apply for the job opening uploads their profile, at 104, through a designated website. The website typically provides an on-line form where the candidate enters details about his or her application like personal information, education and experience details, skills, etc. The candidates can also upload their resumes through the website.

Once the applications of prospective candidates are received, they are subjected, at 110, to careful scrutiny by a set of screeners. In order to perform this screening properly, the screeners need to understand the requirement for the job opening, in terms of the skills that are mandatory and those that are optional but preferable, the experience criteria if any, preference for the location of the candidate, and other factors.

The screeners look through each of the applications and, at 112, reject the candidates that do not have the experience or the skills for the job. Of the remaining candidates, the screeners, at 114, attempt to find the best match for the job. This requires the recruiter to read the resume in detail and compare it with the job profile. Since the number of candidates who can be interviewed is limited, the recruiter has to make a relative judgment on the candidates. The top few candidates who are shortlisted, at 116, during the screening, undergo further evaluation in the form of interviews 120, written tests, group discussions etc. The feedback from these evaluation processes is used to make the final hiring decision 122.

Recruitment is a costly process. The process may require expenses for the use of agencies and advertising, and also requires a significant amount of human resources. Time is needed for interviews, and substantial expenses may be incurred when offering a job to an individual and to hire and to incorporate a person into an organization.

An additional cost of the process is the cost resulting from hiring the incorrect person for a job. These costs may include low productivity, attrition and associated losses (including lost revenue), and re-hiring costs.

It is imperative to hire candidates which maximize quality as well as minimize the cost of hiring.

FIG. 2 identifies some dimensions that can affect the quality of a candidate. These dimensions include, but are not limited to, the technical match, the screening match, and an onboard probability. Technical match is the match between the skills of a candidate and the job requirement, and screening match refers to how likely the candidate is to pass the screening. Onboard probability is a measure of how likely the candidate is to accept and join the organization if offered a job.

Other dimensions that help to define the quality of the candidate include early attrition probability, or whether the candidate is likely to be a long term employee. Early attrition probability is a measure of how likely the candidate is to leave or not to leave in a relatively short period, such as six to nine months after joining the organization. The long term employee probability is a measure of how likely the candidate is to be with the organization for a long term. Additional dimensions include the candidate's likely productivity and leadership role.

Ideally, a good candidate would have high scores in all of these dimensions; however, this is not feasible in many or most cases.

There also are significant costs associated with the hiring process. The cost of hiring is directly related to the number of candidates evaluated, which itself is a function of the size of the candidate pool and the variation in the candidate pool quality.

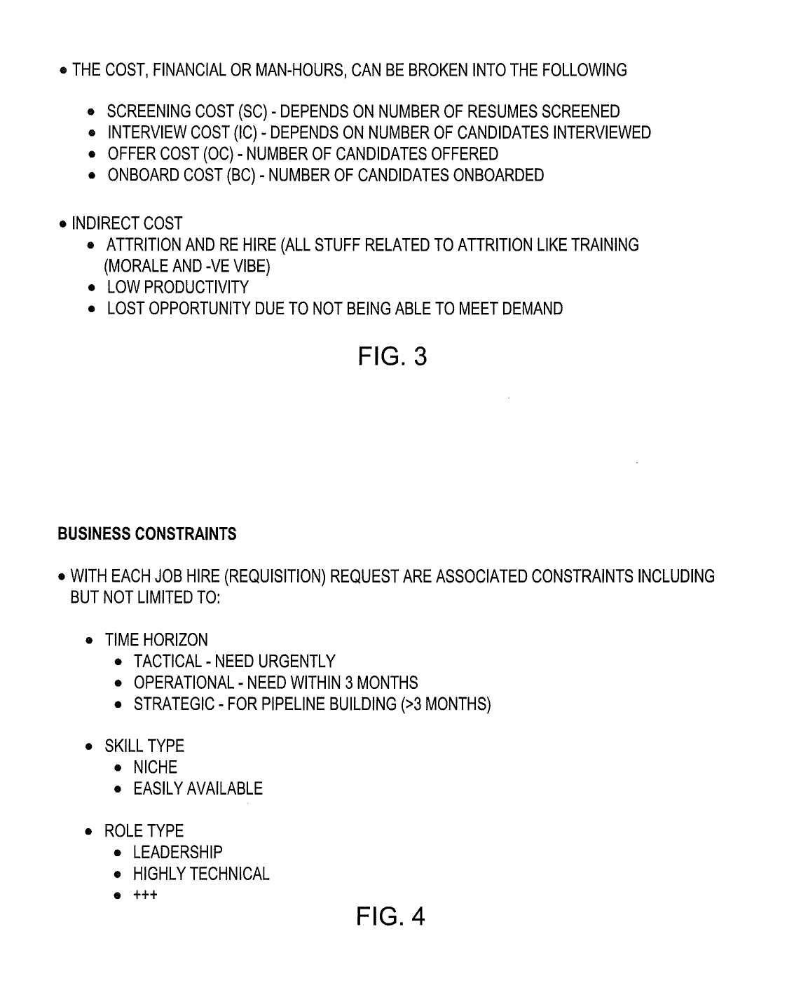

FIG. 3 shows some specific costs of the hiring process. These costs, financial or time, include the following: Screening Cost (SC); Interview Cost (IC); Offer cost (OC); and Onboard Cost (OBC). The screening cost depends on the number of resumes screened, and the interview cost depends on the number of candidates interviewed. The offer cost depends on the number of candidates that are offered jobs, and the onboard cost depends on the number of candidates who become employees.

There also are indirect costs. For example, while an organization is looking for an additional employee, the morale of current employees may decrease, and there may be increased attrition of these current employees due to the fact that the organization does not have all the employees it needs. In addition, an organization may have low productivity and there may be lost opportunities during the hiring process due to the fact that the organization is understaffed.

The cost of the hiring process can be decreased if the number of candidates to be evaluated is kept at a minimum while still meeting quality requirements and demand.

Business constraints also affect the hiring process and need to be taken into account. Each job hire (requisition) request may be associated with a number of constraints. As indicated in FIG. 4, these constraints may include, but are not limited to, a time horizon, a skill type, and a role type. The need to hire a person may be tactical (urgently needed), operational (needed within three months), or strategic (needed in more than three months). Some skill types are rare (niches), while other skill types are readily available. Some employees are hired for leadership roles, and others may be hired because of their technical skills.

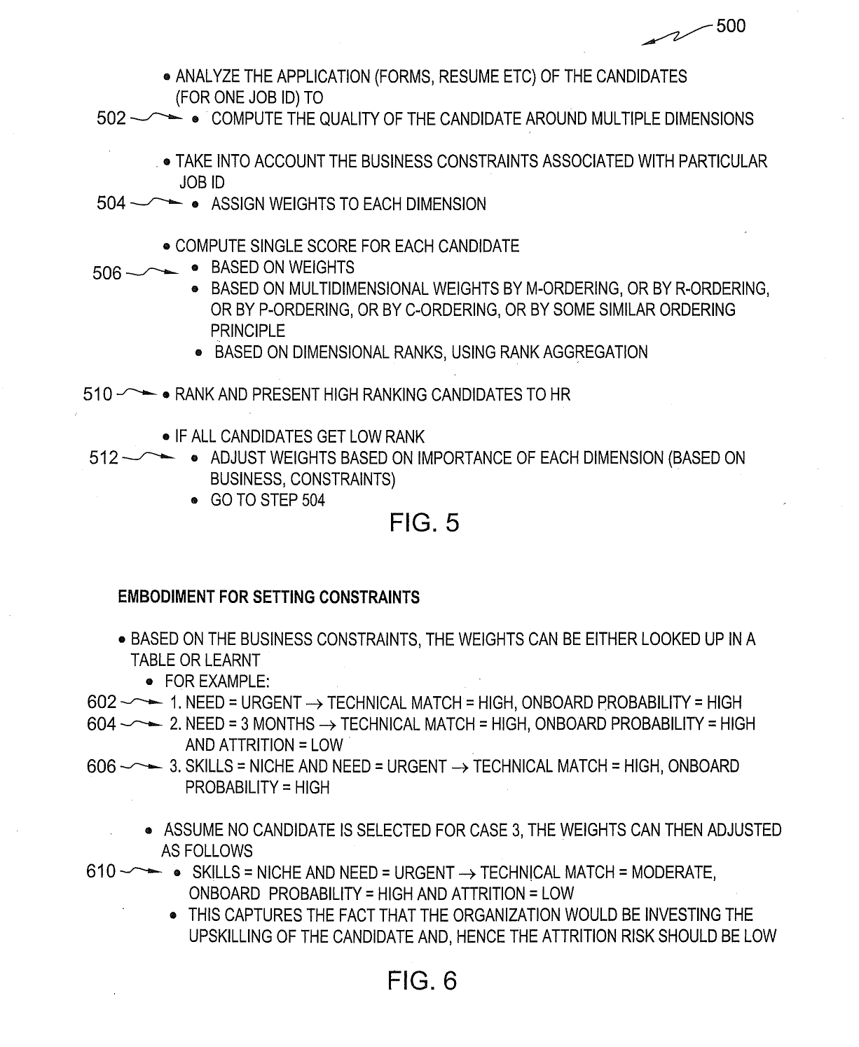

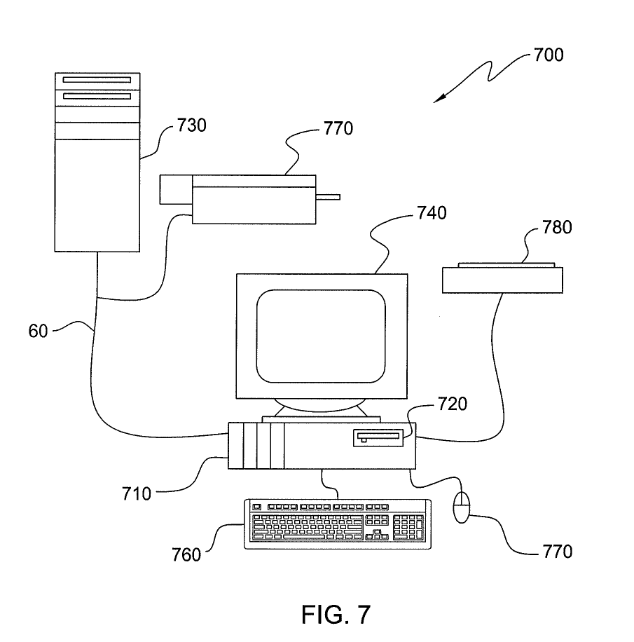

FIG. 5 illustrates an approach 500, in accordance with an embodiment of the invention, for multifaceted candidate screening. Generally, this approach is, at 502, to analyze the applications (form, resumes, etc.) of the candidates (for one job ID). This analysis is done to compute the quality of each candidate around multiple dimensions. This analysis, at 504, takes into account the business constraints associated with a particular job ID by assigning weights or values to each dimension.

A single score is computed, at 506, for each candidate. The score for each candidate is based on the above-mentioned weights or values that are assigned to each dimension. This score is also based on multidimensional weights by M-ordering, R-ordering, P-ordering, or C-ordering, or by some similar ordering principle. Each candidate's score is based on dimensional ranks, using rank aggregation.

Each candidate is assigned multiple weights based on probability of joining, attrition, technical match, and other factors. These scores can be combined using different algorithms. The simplest would be to take the simple average of all scores, or rank aggregation methods can be used.

M-ordering is marginal ordering: ranking according to one component;

R-ordering is reduced (aggregate) ordering: ranking by creating a scalar representation of the multivariate data and then ranking according to that (e.g. linear combination);
P-ordering is partial ordering: trying to essentially see if certain samples stochastically dominate others in all dimensions and creating a partially ordered set (like a lattice)
C-ordering is conditional (sequential) ordering: this ordering is like M-ordering, but continuing on with the various component dimensions in sequence.
P-ordering would result in a lot of ties if it is used for scoring. M-ordering would basically ignore certain aspects of the multivariate data. C-ordering would be useful if certain dimensions were clearly more important than others.

As an example, two candidates may have the following scores on various dimensions (higher is better),

| | | | Attrition |
|---|---|---|---|
| | Technical Match | Onboard Probability | Probability |
| Candidate A | 5 | 3 | 1 |
| Candidate B | 4 | 5 | 4 |

One way to compute the scores is a weighted average.

Candidate A=0.3*5+0.3*3+0.4*1=2.9

Candidate B=0.3*4+0.3*5+0.4*4=3.1

So, candidate B is more favorable (given the weight vector 0.3, 0.3, 0.4)
However, some other ranking may give more weight to the technical match and A can be more favorable.

Once the scores are computed, the candidates are ranked, at 510, and high ranking candidates may be presented to a human resources department or group. If all the candidates get a low score, below a given or determined threshold, their scores are recomputed, at 512, with changed weights or values. For example, the weights may be adjusted based on the importance of each dimension (based on business constraints). After the scores are re-computed, the candidates are re-ranked, and high ranking candidates may be presented to a human resources department or group.

Weights for the dimensions may be taken from a table, or determined as needed. Also, the weights may be determined based on history.

FIG. 6 illustrates three examples of business constraints and assigned weights. In example 602, the need to hire a person is urgent, the candidate's technical match to the job needs to high, and the candidate's onboard probability also needs to be high. As another example 604, a position may need to be filled within three months, the candidate's technical match to the job needs to be high, the candidate's onboard probability needs to be high, and the attrition risk of the candidate needs to be low. As a third example 606, the position requires niche shills, the need to fill the position is urgent, and both a candidate's technical match to the position and the candidate's onboard probability need to be high.

If for instance, no candidate is found for the third example, the weights can be adjusted, as shown at 610, so that the position requires niche skills, the need to hire a person is urgent, the candidate's technical match to the position needs to be moderate, a candidate's onboard probability needs to be high and the candidate's attrition risk is low. This adjustment to the weights captures the fact that the organization would be investing in improving the skills of the candidate, and hence the candidate's attrition risk should be low.

Consider, as another example, the following rule:

### Need=URGENT, Technical Match=High, Onboard Probability=High.

This rule indicates that if the organization needs a candidate urgently, then the technical match threshold and onboard probability should be HIGH. If no candidate is found at high thresholds, then the thresholds are reduced to MEDIUM.

A computer-based system 700 in which a method embodiment of the invention may be carried out is depicted in FIG. 3. The computer-based system 700 includes a processing unit 710, which houses a processor, memory and other systems components (not shown expressly in the drawing) that implement a general purpose processing system, or computer that may execute a computer program product. The computer program product may comprise media, for example a compact storage medium such as a compact disc, which may be read by the processing unit 710 through a disc drive 720, or by any means known to the skilled artisan for providing the computer program product to the general purpose processing system for execution thereby.

The computer program product may comprise all the respective features enabling the implementation of the inventive method described herein, and which—when loaded in a computer system—is able to carry out the method. Computer program, software program, program, or software, in the present context means any expression, in any language, code or notation, of a set of instructions intended to cause a system having an information processing capability to perform a particular function either directly or after either or both of the following: (a) conversion to another language, code or notation; and/or (b) reproduction in a different material form.

The computer program product may be stored on hard disk drives within processing unit 710, as mentioned, or may be located on a remote system such as a server 730, coupled to processing unit 710, via a network interface such as an Ethernet interface. Monitor 740, mouse 770 and keyboard 760 are coupled to the processing unit 710, to provide user interaction. Scanner 780 and printer 770 are provided for document input and output. Printer 770 is shown coupled to the processing unit 710 via a network connection, but may be coupled directly to the processing unit. Scanner 780 is shown coupled to the processing unit 710 directly, but it should be understood that peripherals might be network coupled, or direct coupled without affecting the performance of the processing unit 710.

The description of the present invention has been presented for purposes of illustration and description, and is not intended to be exhaustive or to limit the invention in the form disclosed. Many modifications and variations will be apparent to those of ordinary skill in the art without departing from the scope of the invention. The embodiments were chosen and described in order to explain the principles and application of the invention, and to enable others of ordinary skill in the art to understand the invention. The invention may be implements in various embodiments with various modifications as are suited to the particular use contemplated.

What is claimed is:

1. A method of multidimensional candidate screening, comprising:
identifying a multitude of dimensions of a specified job;
assigning a weight to each of the dimensions based on defined constraints;
for each of a multitude of candidates for the specified job, determining whether said each candidate satisfies the weights assigned to each of the dimensions;
assigning a score to each of the candidates based on whether said each candidate satisfies the weights assigned to said dimensions;
determining the number of the candidates that have a score above a defined threshold; and
if the number of the candidates that have a score above the defined threshold is less than a defined number, adjusting one or more of the weights; and repeating the steps of determining whether said each candidate satisfies the weights assigned to each of the dimensions, assigning a score to each of the candidates, and determining the number of the candidates that have a score above the defined threshold.

2. The method according to claim 1, wherein the assigning a weight to each of the dimensions includes:
assigning an importance two each of the dimensions; and
assigning the weight to each of the dimensions based on the importance assigned to said each of the dimensions.

3. The method according to claim 1, wherein:
the adjusting one or more of the weights includes adjusting one or more of the weights based on the number of the candidates that have a score above the defined threshold.

4. The method according to claim 1, wherein the adjusting one or more of the weights includes adjusting at least one of the weights based on the other weights assigned to the dimensions.

5. The method according to claim 1, wherein the adjusting one or more of the weights includes adjusting at least one of the weights based on the scores assigned to one or more of the candidates.

6. The method according to claim 1, wherein the defined number is one.

7. The method according to claim 1, wherein the assigning a score to each of the candidates includes:
ordering the dimensions according to a defined ordering principle; and
assigning a score to each of the candidates based on the order of the dimensions to which the weights are assigned.

8. The method according to claim 1, wherein the specified job is for a specified organization, and the dimensions of the specified job include:
a technical match between each of the candidates and the specified job;
a screening match representing a probability that each of the candidates will pass a screening test;
an onboard probability representing a probability that each candidate would accept an offer for the specified job; and
an early attrition probability representing a probability that each candidate would permanently leave the organization within a specified time of joining the organization.

9. The method according to claim 1, wherein the specified job is for a specified organization, and the defined constraints include:
a time horizon indicating a time at which the organization needs to employ a person for the specified job;
a skill type indicating an availability of the type of skill needed for the specified job; and
a role type indicating a type of role for a person who accepts the specified job.

10. The method according to claim 1, further comprising:
using a computer system, executing a candidate screening program, to perform the determining whether said each candidate satisfies the weights assigned to each of the dimensions, assigning a score to each of the candidates based on whether said each candidate satisfies the weights assigned to said dimensions, and determining the number of the candidates that have a score above a defined threshold.

11. A system for multidimensional candidate screening, comprising:
one or more processing units, for implementing a candidate screening program, configured for:
identifying a multitude of dimensions of a specified job;
assigning a weight to each of the dimensions based on defined constraints;
for each of a multitude of candidates for the specified job, determining whether said each candidate satisfies the weights assigned to each of the dimensions;
assigning a score to each of the candidates based on whether said each candidate satisfies the weights assigned to said dimensions;
determining the number of the candidates that have a score above a defined threshold; and
if the number of the candidates that have a score above the defined threshold is less than a defined number, adjusting one or more of the weights; and repeating the steps of determining whether said each candidate satisfies the weights assigned to each of the dimensions, assigning a score to each of the candidates, and determining the number of the candidates that have a score above the defined threshold.

12. The method according to claim 11, wherein the assigning a weight to each of the dimensions includes:
assigning an importance two each of the dimensions; and
assigning the weight to each of the dimensions based on the importance assigned to said each of the dimensions.

13. The method according to claim 11, wherein:
the adjusting one or more of the weights includes adjusting one or more of the weights based on the number of the candidates that have a score above the defined threshold.

14. The method according to claim 11, wherein the adjusting one or more of the weights includes adjusting at least one of the weights based on the other weights assigned to the dimensions.

15. The method according to claim 11, wherein the adjusting one or more of the weights includes adjusting at least one of the weights based on the scores assigned to one or more of the candidates.

16. An article of manufacture comprising:
at least one tangible computer readable device having computer readable program code logic tangibly embodied therein to provide multidimensional candidate screening, the computer readable program code logic, when executing, performing the following:
receiving input for identifying a multitude of dimensions of a specified job;
assigning a weight to each of the dimensions based on defined constraints;
for each of a multitude of candidates for the specified job, determining whether said each candidate satisfies the weights assigned to each of the dimensions;
assigning a score to each of the candidates based on whether said each candidate satisfies the weights assigned to said dimensions;
determining the number of the candidates that have a score above a defined threshold; and
if the number of the candidates that have a score above the defined threshold is less than a defined number, adjusting one or more of the weights; and repeating the steps of determining whether said each candidate satisfies the weights assigned to each of the dimensions, assigning a score to each of the candidates, and determining the number of the candidates that have a score above the defined threshold.

17. The article of manufacture according to claim 16, wherein the assigning a weight to each of the dimensions includes:
assigning an importance two each of the dimensions; and
assigning the weight to each of the dimensions based on the importance assigned to said each of the dimensions.

18. The article of manufacture according to claim 16, wherein:
the adjusting one or more of the weights includes adjusting one or more of the weights based on the number of the candidates that have a score above the defined threshold.

19. The article of manufacture according to claim 16, wherein the adjusting one or more of the weights includes adjusting at least one of the weights based on the other weights assigned to the dimensions.

20. The article of manufacture according to claim 16, wherein the adjusting one or more of the weights includes adjusting at least one of the weights based on the scores assigned to one or more of the candidates.
